(19) United States
(12) Patent Application Publication
(10) Pub. No.: US 2024/0231746 A1
(43) Pub. Date: Jul. 11, 2024

(54) SYSTEM AND METHOD FOR CONTROLLING AN AUDIO DEVICE

(71) Applicant: Harman Becker Automotive Systems GmbH, Karlsbad (DE)

(72) Inventor: Victor KALINICHENKO, Putzbrunn (DE)

(21) Appl. No.: 18/559,545

(22) PCT Filed: May 7, 2021
(86) PCT No.: PCT/EP2021/062151

§ 371 Date: Nov. 7, 2023

(51) Int. Cl. G06F 3/16; B60K 35/10; G06F 16/632

(52) U.S. Cl. CPC G06F 3/16; B60K 35/10; G06F 16/634

(57) ABSTRACT

A method for controlling an audio device, the method comprising: receiving an input representing at least one acoustic or haptic pattern; determining an audio file containing the pattern; controlling the audio device to indicate or play back the audio file.

### FIELD

The present disclosure relates to systems, methods, and devices for controlling audio devices.

### BACKGROUND

The present disclosure relates to controlling an audio device, in particular an audio device in a vehicle.

US20190246936A1 discusses a system and a method for associating music with brain-state data.

CN105740420A relates to a song switching method for controlling an audio device. Said method comprises detecting a melody, e. g. a melody sung by a user. However, CN105740420A does not relate to detecting an acoustic pattern.

CN101499268A relates to an apparatus for automatically generating music structural interface information.

### SUMMARY

Disclosed and claimed herein are systems, methods, and devices for controlling audio devices.

A first aspect of the present disclosure relates to a method for controlling an audio device. The method comprises the steps of:
receiving an input representing an acoustic or haptic pattern;
determining an audio file containing the pattern;
controlling the audio device to indicate, play back, or store the audio file.

The input received by the method represents an acoustic or haptic pattern, i. e. regular change of a sound or touch over time. The input may be received from a user and detected by a sensor. The pattern is then used to determine an audio file that contains the pattern. The audio file may either be searched in a database, or created to contain the pattern as described below. The audio file is then played back.

This method allows a user to control an audio device simply by drumming a pattern, which is more intuitive than selecting an audio file, e. g. by selecting a title.

A haptic pattern represents a pattern generated by haptic means, e.g. by touching or pressing a surface, without necessarily generating an (audible) acoustic pattern at the same time. For example, a user clenching a steering wheel and thereby exerting a force onto the steering wheel, may do so in a way that the force changes over time, at a pattern that may comprise a rhythm. This pattern may be detected by a force or touch sensor. Using this input, an audio file may be determined that comprises a corresponding pattern which indicates an acoustic pattern, such as a rhythm, that becomes audible when the audio file is played back.

In an embodiment, the pattern comprises a rhythm. Thereby, the audio file may comprise a song which contains the rhythm. This allows a user to select an audio file even when (typically) unconsciously drumming a rhythm.

In a further embodiment, the step of receiving an input is performed by at least one sensor, comprising one or more of an audio sensor, an accelerometer, a force gauge, and/or a touch sensor. An audio sensor may comprise a microphone to detect the sound waves generated, e. g. when a user is drumming a rhythm on a fixed surface. An accelerometer, disposed on a surface that is accessible to the user, may detect mechanical movement caused by touch or drumming. A force gauge may be comprised in an object that a user can grip, so that rhythmic movement when gripping the object can be detected. A touch sensor, e. g. a capacitive touch pad, can detect whether a user touches an object or not. These sensors may be used alone or in combination.

In a further embodiment, the sensor is arranged in a vehicle. A driver of a vehicle typically has to focus his attention on the traffic, and operating an audio system can be a potentially dangerous distraction. The present input method does not require removing the hands from the steering wheel, and it leads only to a limited increase in cognitive load of the driver. Using the method in a vehicle therefore provides a more intuitive way of operating a car audio system, thereby increasing the traffic safety.

In a further embodiment, the sensor is attached to or comprised in one or more of a steering wheel, a dashboard, an armrest, or a door of the vehicle. These objects are typical positions where drivers and passengers of a vehicle place their hands. This allows recognising a pattern that a driver is producing unconsciously, or when paying most attention to the traffic situation.

In a further embodiment, the method further comprises receiving a second input representing a melody. The second input can be indicative of a user humming or singing a part of a song. This, in combination with the acoustic pattern, allows more reliable recognition of the audio file.

In a further embodiment, the method further comprises applying a noise filter to the input. A noise filter removes a stochastic (irregular) or regular part of the audio file, e.g. road noises, audible part of disturbances applied to the car, engine sounds, etc. This yields a more meaningful signal.

In a further embodiment, the method further comprises storing the input in a storage device. Thereby, a record of past inputs can be kept, so as to allow an analysis of the user's preferences. Furthermore, storing the input allows caching the input in case the network connection is lost and parts of the method are executed on a network server.

In a further embodiment, determining an audio file comprises searching an audio file associated with the pattern in a database. In this embodiment, the method allows the user to choose an audio file to be played back, e. g. a song, by an acoustic pattern comprised in the audio file. Thereby, a song with a particular rhythm can be specified. If complemented by a melody as a second input, the choice can be made accurately. If no second input is chosen, the choice can also be deliberately inaccurate, so that a song is, in part, chosen at random which comprises a particular rhythm. This can be a desired feature. As far as the user is driving a vehicle, the distraction is reduced and the traffic safety is increased. The above database can be local, i.e. stored in one of the devices in the car, or remote, i.e. stored outside the car and accessible using available ways for remote data transfer.

In a further embodiment, determining an audio file further comprises classifying the found audio files associated with the pattern, based on an association of the audio files with the melody, metadata related to the audio files, and/or usage statistics. The classification can allow distinguishing an audio file by its melody to determine the audio file precisely. The metadata comprise, but are not limited to, a fingerprint of the melody and/or the rhythm, or information on genre or the artist performing on the recording. The audio files may be classified to determine which one fits the preferences of a user most.

In a further embodiment, determining an audio file comprises composing an audio file associated with the pattern. This allows using the method as an input device for an audio composing system. In particular, composing systems based on deep neural networks are known to offer a way to compose a song in a predefined style. Using the pattern as an input may add to the flexibility to the usage of such systems.

In a further embodiment, classifying the found audio file and/or composing an audio file is further based on a program selected by a user, and/or one or more sensor inputs generated by sensors comprised in or attached to the vehicle or a vehicle.

The method may thus be customised. If for example, the user configures the system such that a predetermined genre is indicated, then only audio files pertaining to the genre are to be used. In case the method is used to control a vehicle audio system, the setting may be related to vehicle settings. If, for example, the user selects a “Sport”, or “Race” driving program, more aggressive audio can be preferred, for example by selecting Hard Rock as a genre for composing and/or classifying audio.

Furthermore, information from car sensors can be used. Weather data obtained, e. g., by temperature or rain sensors can be used. If, for example, a user prefers a different style of music during rain than during sunshine, this may be taken into account either by a predetermined setting, or by analysis of usage statistics. Similarly, an input may be received from a clock to fit the determination of the audio file to a preference of a user for different style of music at different times a day. Furthermore, mood-correlated data from sensors may be used: For example, images of a user's face can be taken by a camera, an eye openness can be determined, and a mental state can be inferred. For example, drowsiness may be detected. Accordingly, not only the volume of the audio system may be set to a higher value in response to drowsiness, but also an audio file of, e. g., a different genre may be chosen. Other examples for input sensors include the speed of the car, usage of the gas pedal, and choice of gears to adapt to the user's driving behaviour.

Yet another example for a car sensor to be used is one or more scales to determine the weight of persons seated in the car. If a weight of a passenger is in a predetermined range typical for a child, an audio file with music preferred by children may be chosen.

A vehicle may comprise a plurality of audio systems, for which individual audio files may be chosen by executing the steps of the method separately for each audio system.

In a further embodiment, the audio file is further associated with the melody. By using both a melody and a pattern, both composing and searching a file are done more accurately.

In a further embodiment, the step of determining an audio file is executed by a network-accessible server. This allows to access publicly-available cloud-based song databases, as used in streaming services. Furthermore, this allows offloading the steps of searching and composing, which lead to a high computational load, to a server in a datacentre. This means that the local components need not comprise components with a particularly high compute power.

In a further embodiment, the method further comprises storing the audio file in a memory, wherein the memory is comprised in the audio device and/or a network-accessible server.

This is particularly advantageous if determining the audio file comprises composing an audio file associated with the pattern. An audio file may be created by a neural network running on a server, e. g. part of a cloud-based service, that composes the audio file. The audio file may then be saved in a memory on another server, or on a local device to be available to be played back again at a future time. This increases the compatibility with specialised services and servers.

Storing the audio file may be conditional on receiving a command, such as a control input as detailed below, a speech input, or a melody input associated with the step of storing the audio file.

In a further embodiment, the method further comprises the steps of:
a. receiving a control input comprising a second pattern,
b. searching an instruction stored in a control database, wherein the instruction is associated with the second pattern, and
c. executing the instruction in response to finding the instruction.

Such a control input may comprise a predefined rhythm associated with a command. The detection and processing steps for the above-mentioned acoustic pattern may also be applied to the second pattern. For example, the control input may be detected with the touch sensor, and a noise or disturbance filter may be applied.

In particular, the step of storing the audio file in the memory may be executed in response to receiving the control input and in response to receiving a control input indicative of a user's command to store the audio file.

A second aspect of the present disclosure relates to a system for controlling an audio device. The system comprises at least one sensor configured to receive an input representing an acoustic or haptic pattern and at least one computing device. The computing device is configured to:
determine an audio file containing the pattern;
control the audio device to indicate, play back, or store the audio file.

The computing device may comprise a digital signal processor, DSP. The computing device may comprise components that are in part installed in a vehicle, a mobile device, and/or a network-accessible server.

All properties and embodiments that apply to the first aspect also apply to the second aspect.

### BRIEF DESCRIPTION OF THE DRAWINGS

The features, objects, and advantages of the present disclosure will become more apparent from the detailed description set forth below when taken in conjunction with the drawings in which like reference numerals refer to similar elements.

FIG. 1 shows a flow chart of a method for controlling an audio device according to an embodiment;

FIG. 2 shows a flow chart of a method for determining an audio file according to an embodiment;

FIG. 3 shows a block diagram of a system according to an embodiment;

FIG. 4 shows a block diagram of a client-server system according to an embodiment; and

FIG. 5 shows a top view (a) and a side elevation (b) of a vehicle with a system according to an embodiment.

### DETAILED DESCRIPTION OF THE PREFERRED EMBODIMENTS

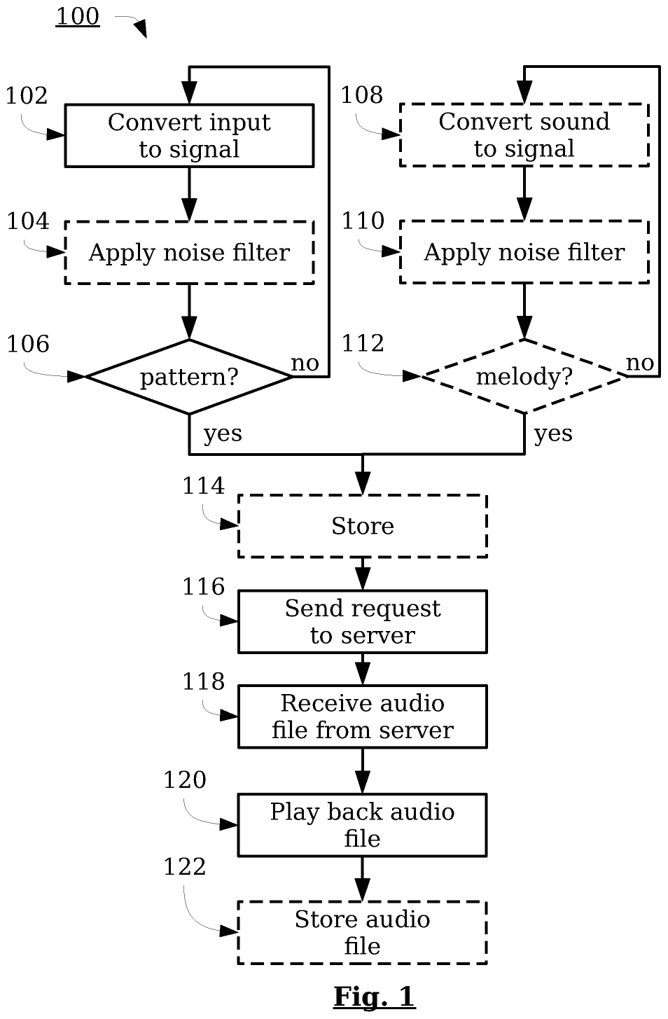

FIG. 1 shows a flow chart of a method 100 for controlling an audio device according to an embodiment. An input, which may or may not comprise an acoustic or haptic pattern, is received by the system. The input can, for example, relate to a user drumming onto an armrest or gripping a steering wheel. The input is converted, 102, to an electric signal, by, e. g., a touch sensor, a microphone, or an accelerometer. The signal may then, optionally, be de-noised by noise filtering, e. g. removing stochastic (irregular) variations, 104. The signal is then processed in order to determine whether a pattern, i. e. a regular change in the signal over time, is present, 106. If this is not the case, the method loops back to block 102. Thereby, a continuous input can be treated, and a pattern can be detected.

Optionally, a second input, relating to sound, can be converted to a signal 108. A noise filter may be optionally applied, 110, and it may be determined if the sound comprises a recognizable melody, 112. Thereby, a melody hummed or sung by a user may be determined. The melody recognition may be advantageous because a user is likely humming a melody and drumming a rhythm of the same song. The use of both signals, e. g. when searching for an audio file, 206, or composing, 210, can increase the accuracy of the result.

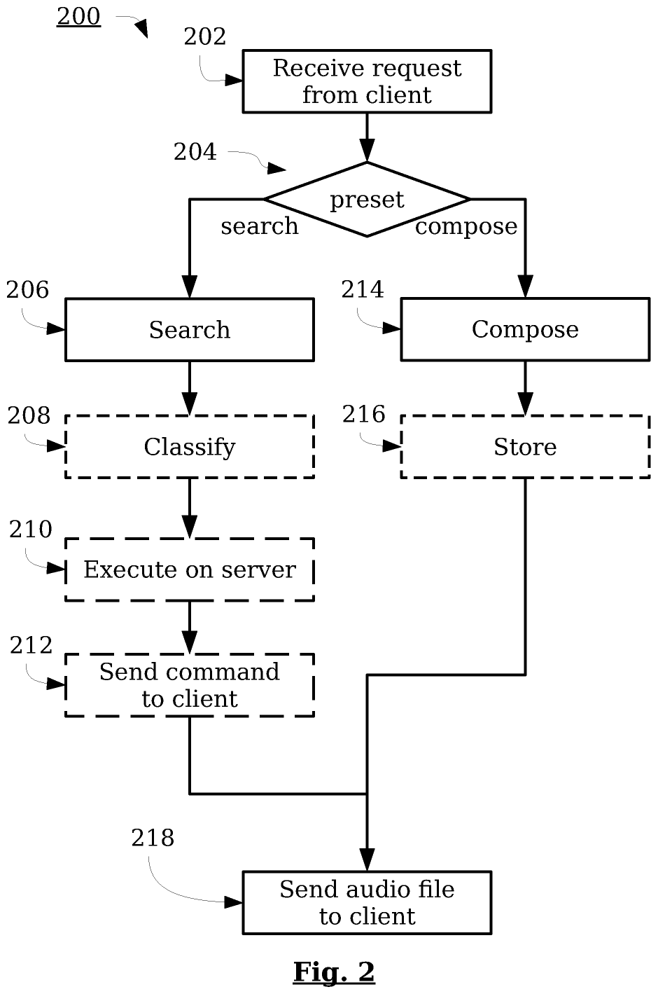

Both signals may be optionally stored, 114, in a storage device. In this exemplary embodiment, a local storage device is used to store the pattern and, preferably, also the melody for an appropriate duration, before sending, 116, a request for determining an audio file, e. g. by composing or searching, to a server. The request may comprise one or both recorded signals. In an embodiment, the request contains an acoustic fingerprint of the signal or signals. A fingerprint, a compressed version of the signal, comprises the data that are most relevant for recognition. The request may further comprise user inputs and/or settings on a preferred genre, or which operations are preferred, as described with reference to FIG. 2 below. At 118, an audio file is received that is then played back, 120, by the audio system. The audio file may be either received in full and played back, or streamed and simultaneously played back. In an alternative embodiment, all steps may be executed by local devices, which allows using the methods 100 and 200 without any network access. The audio file may be stored, 122, in a local and/or remote memory. In yet an alternative embodiment, the noise filtering. 104, 110, and the pattern and/or melody recognition, 106, 112, as well as storing may be done by one or more remote devices.

FIG. 2 shows a flow chart of a method 200 for determining an audio file according to an embodiment. The server receives, 202, a request to determine an audio file. The request may comprise one or more pattern/melody signals or fingerprints thereof. The request may further comprise user settings, such as whether the server is supposed to search for an audio file in a database or to compose a new audio file. This preference preset may alternatively be stored on the server or a different network-accessible storage. If it is set to searching, the server will search in a database an audio file that matches the pattern and/or the melody. For example, a search for the pattern, e. g. a rhythm in the song, may yield a plurality of results, i. e. audio files that are good candidates for a match. They may comprise songs having the rhythm as drummed by the user. The next step is then, optionally, classifying, 208, the results to determine a matching audio file. The step of classifying may comprise using data from sensors attached to or comprised in the client system and included in the request received at 202. For example, a music genre may be chosen according a determination of eye openness or vehicle speed, based on inferring a driver's mental state. In order to find the file the most likely to be the correct match, it may then be determined if the melody is comprised in the audio file as well. Furthermore, other settings by the user in the request or stored in a memory, such as preferences for a genre, may be used to determine a matching audio file. Alternatively, the audio file may be determined relying only on the rhythm. Optionally, the search, 206, and/or classification, 208, may allow distinguishing whether the pattern relates to an audio file, or to a command. The database may comprise one or more stored commands associated to different patterns. For example, a pattern comprising a Morse code of predefined letters may cause identification of a command. In the optional blocks 210-212, the command may be executed on the server and/or sent to the client to be executed there.

If the pre-set is set to composing an audio file, the system may use the pattern and/or the melody to algorithmically compose a song, 214. This may be further steered by user inputs, e. g. settings comprised in the request. For example, an algorithm may compose a song with the rhythm and/or melody in a given style (e. g. a music genre) according to user settings. The song may optionally be stored, 216, in on a server, in particular a file server distinct from the server executing step 214. At 218, the audio file thus determined is sent to the client device for playback.

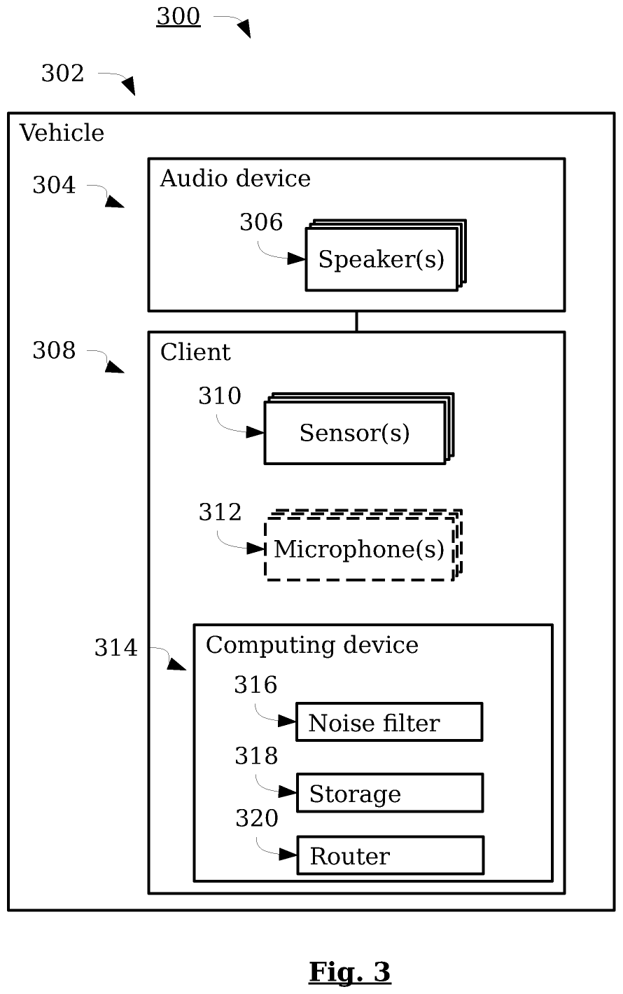

FIG. 3 shows a block diagram of a system 300 according to an embodiment.

The system 300 is, in this embodiment, disposed in a vehicle 302 and comprises an audio device 304 comprising one or more speakers 306, and a client 308 as part of an input device. The audio device 304 may comprise a car audio system, comprising, for example, a functionality to play back streaming audio files and stored audio files. The audio device 304 can be controlled by the client 308 to play back certain audio files. Furthermore, the audio device 304 may comprise an output to the client 308 that indicates a status of the audio device. If the audio device is disabled or currently playing back an audio file selected by the user, the client 308 may be inactive. If the audio device is enabled but not playing back an audio file, the client may be configured to receive an input and determine an audio file as described. This is, however, only an illustrative example of a system. In alternative embodiments, the system may be installed in, e. g., a building or any other environment.

The client 308 comprises one or more sensors 310 which are configured to capture an acoustic or haptic pattern, i. e. to convert the input into a signal. A pattern may include any regular temporal change in a physical quantity, in particular acoustic waves generated when, e. g., a user is drumming a rhythm. A sensor to detect the pattern may comprise a microphone to convert the acoustic waves into an electric signal. However, the pattern may alternatively or additionally be captured by a touch sensor, an accelerometer, or a force gauge. The pattern may thus further comprise a haptic pattern, for example when the user is rhythmically pressing on a given position on the steering wheel. This may be detected by a touch sensor or by one or more touch buttons which yield a signal when the button is pressed. Preferably, the sensors comprise one or more force gauges, which yield a continuous output signal that varies depending on the force exerted on the sensor. Any of these sensors 310 may be disposed on a steering wheel, an arm rest, or a part of the door where the user, typically the driver of the vehicle 302, can rest his hands. Thereby, the sensor or sensors may capture an input that generated by unconscious movements of the user. The optional one or more microphones 312 are configured to capture sound in addition to the acoustic input related to the pattern. For example, a user singing or humming a melody may generate a detectable signal. The client 308 further comprises a computing device 314 configured to execute one or more processing steps. The computing device 314 comprises a noise filter 316 to remove irregular, i. e. stochastic, parts of the signals from one or more of the sensors 310 and/or microphones 312. The computing device may further comprise a storage device 318, to store the signals before transmitting them to the server. The storage device may further comprise settings entered by the user, such as whether the audio file is to be determined by composing the audio file based on the pattern, or by searching an audio file in a database. Further settings may comprise whether the audio file should preferably contain a song related to a particular genre. The router 320 can be connected via a network to one or more servers. For example, the connection may be effected via the Internet, and data may be transported using a mobile wireless network.

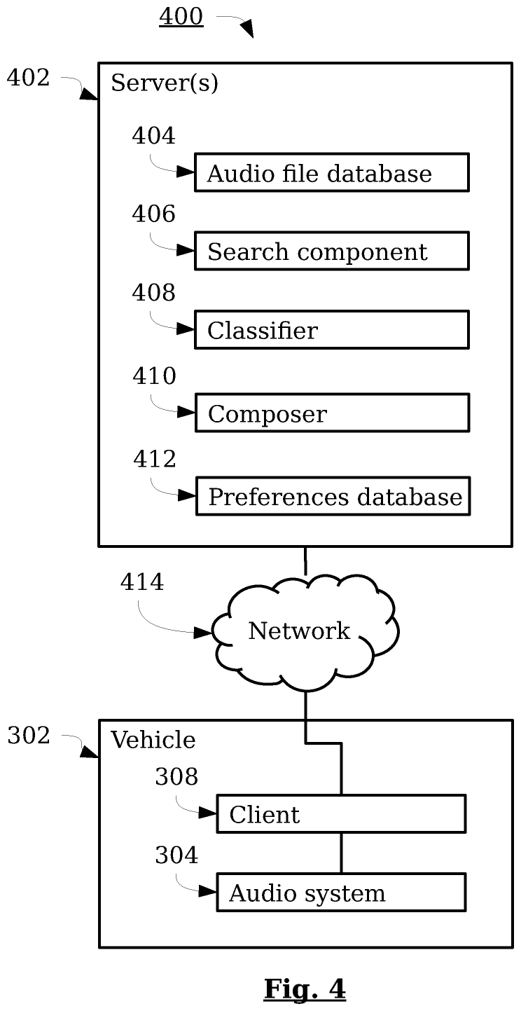

FIG. 4 shows a block diagram of a client-server system 400 according to an embodiment. The client-server system 400 comprises a client system, such as the client described with reference to FIG. 3 above, and which is connected to a server 402 via a network 414. The components and functions of the server may be either concentrated in one server as shown, or distributed over a plurality of servers, for example servers forming part of a cloud. The audio file database 404 comprises audio files that can be played by the audio device. The audio file database 404 may pertain to a music streaming service as known in the art. The search component 406 is configured to analyse an input, such as the pattern and/or melody, and select an audio file accordingly. For example, a search component 406 may use the pattern to determine for a plurality of audio files a probability that the audio file comprises the pattern. Audio files can be excluded if they do not pertain to a genre that is stored as a preferred genre in the user preferences. Thereby, the processing speed is increased by avoiding unnecessary operations. Furthermore, the search may, optionally, be based on an acoustic fingerprint of a rhythm extracted from or related to the audio file. Such a fingerprint may be either stored together with the audio file, as a part of its metadata, or generated on the fly. The result of a search may then comprise a list of audio files together with probabilities that the audio file does comprise the pattern. In an exemplary embodiment, the audio file with the highest probability may be used. Alternatively, a plurality of audio files, e. g. a predefined number of audio files with the highest probabilities, may be further classified by the classifier 408. This may comprise determining a probability for each of the audio files that the audio file further comprises a melody detected substantially at the same time as the pattern. Further classification may be done according to the frequency at which an audio file had been manually selected by the same user, to take into account personal preferences.

These preferences may be either sent from the client to the server with the request, or be stored in a preferences database 412, or a combination thereof.

The composer 410 is configured to create a new audio file based on the pattern and/or the rhythm. The composer 410 may, for example, comprise a deep neural network trained to create an audio file.

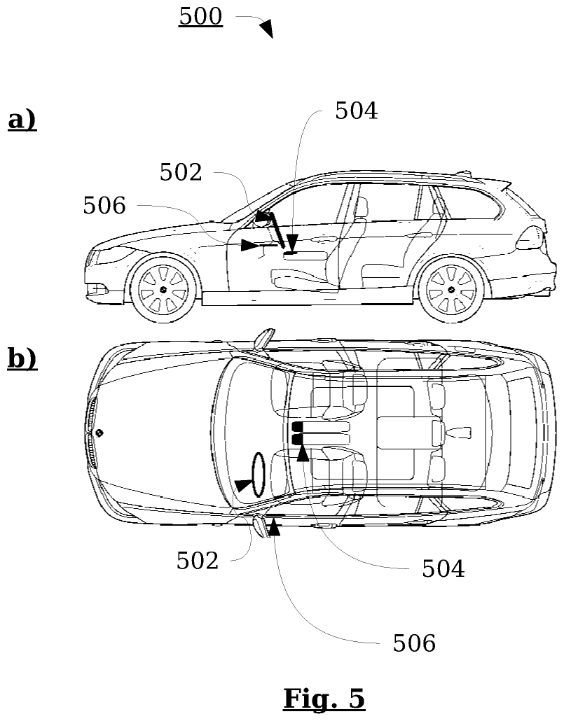

FIG. 5 shows a top view (a) and a side elevation (b) of a vehicle with a system according to an embodiment. In a vehicle 500, sensors are disposed at a steering wheel 502, a door component 504, and/or an armrest 506.

### REFERENCE SIGNS

100 Method for controlling an audio device
102-122 Steps of method 100
200 Method for determining an audio file
202-218 Steps of method 200
300 System
302 Vehicle
304 Audio device
306 Speaker(s)
308 Client
310 Sensor(s)
312 Microphone(s)
314 Computing device
316 Noise filter
318 Storage
320 Router
400 Client-server system
402 Server
404 Audio file database
406 Search component
408 Classifier
410 Composer
412 Preferences database
414 Network
500 Vehicle
502 Steering wheel
504 Door component
506 Armrest

1. A method for controlling an audio device, the method comprising:
receiving an input representing at least one acoustic or haptic pattern;
determining an audio file containing the pattern;
controlling the audio device to indicate, play back, or store the audio file.

2. The method of claim 1, wherein the pattern comprises a rhythm.

3. The method of claim 1, wherein the step of receiving an input is performed by at least one sensor attached to or comprised in the vehicle, preferably comprising one or more of an audio sensor, an accelerometer, a force gauge, and/or a touch sensor.

4. The method of claim 3, wherein the sensor is arranged in a vehicle.

5. The method of claim 3, wherein the sensor is attached to or comprised in reachable distance to a seated driver and/or passenger of the vehicle, preferably one or more of a steering wheel, a dashboard, an armrest, a seat, a seat belt, or a door of the vehicle.

6. The method of claim 1, further comprising receiving a second input representing a melody.

7. The method of claim 1,
further comprising applying a noise or disturbance filter to the input.

8. The method of claim 1,
further comprising storing the input in a storage device.

9. The method of claim 1,
wherein determining an audio file comprises searching an audio file associated with the pattern and/or the or a melody in a database.

10. The method of claim 9,
wherein determining an audio file further comprises classifying the found audio files associated with the pattern, based on an association of the audio files with the pattern, the or a melody, metadata related to the audio files, and/or usage statistics.

11. The method of claim 1,
wherein determining an audio file comprises composing an audio file associated with the pattern.

12. The method of claim 10, wherein classifying the found audio file and/or composing an audio file is further based on a program selected by a user, and/or one or more sensor inputs generated by sensors comprised in or attached to the or a vehicle.

13. The method of claim 6,
wherein the audio file is further associated with the melody.

14. The method of claim 3,
wherein the step of determining an audio file is executed by a network-accessible server.

15. The method of claim 1,
further comprising storing the audio file in a memory,
wherein the memory is comprised in the audio device and/or a network-accessible server.

16. The method of claim 1,
further comprising
receiving a control input comprising a second pattern,
searching an instruction stored in a control database, wherein the instruction is associated with the second pattern, and
executing the instruction in response to finding the instruction.

17. A system for controlling an audio device, the system comprising a processor configured to receive an input representing at least one acoustic or haptic pattern, determine an audio file containing the pattern, and control the audio device to indicate, play back, or store the audio file.
